(19) United States
(12) Patent Application Publication
(10) Pub. No.: US 2004/0013043 A1
(43) Pub. Date: Jan. 22, 2004

(54) Islamic watch

(76) Inventor: Tanveer Ul Haq, Houston, TX (US)

Correspondence Address: TANVEER HAQ, 16230 BROOKFORD DR, HOUSTON, TX, 77059, US

(21) Appl. No.: 10/282,259

(22) Filed: Jul. 16, 2002

(51) Int. Cl. G04B 19/22

(52) U.S. Cl. 368/21

(57) ABSTRACT

An electronic wristwatch utilizing the geographical position system (GPS) to find the time without adjustments for time zones and finding out the direction of Mecca (Direction in which Muslims prostrate during prayers) or any specific point on the earth from anywhere in the world without adjustments. The watch will have the capability to show islamic prayer timings as the day progresses in any part of the world.

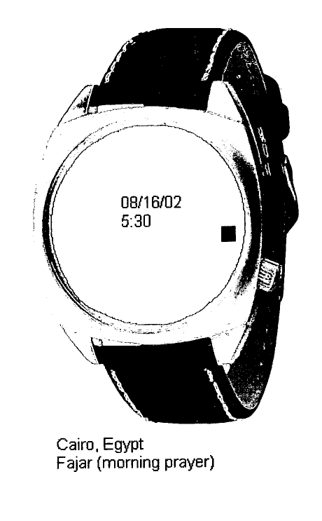

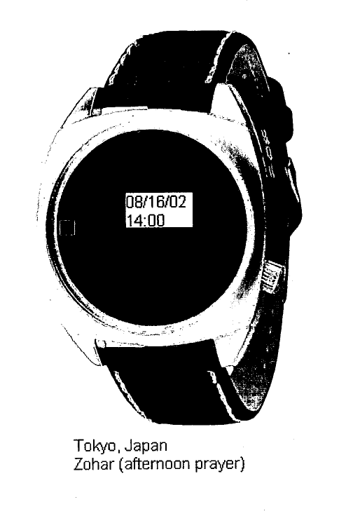

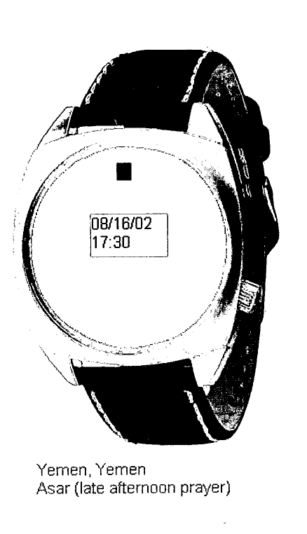

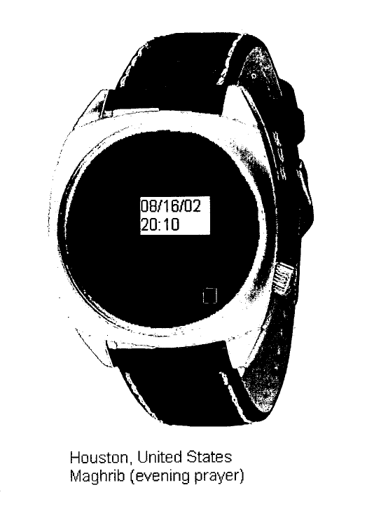

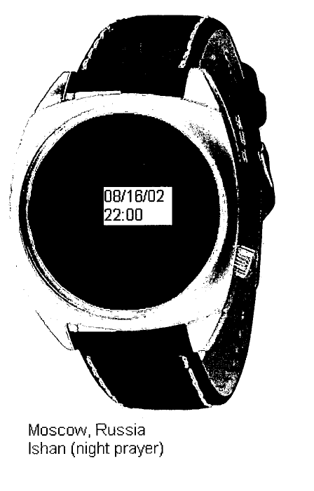

### BACKGROUND OF INVENTION

The invention aims at eliminating the manual adjustments required to change time when one moves form one time zone to another. It also eliminates the need to specify your position on the earth (Latitude and Longitude) to find out the direction of Mecca. Islamic Prayer timings can be tracked by the wristwatch.

### DESCRIPTION

The current technique to find time through a watch requires adjustments when moving form one time zone to another. Adjustments are also required for arbitrary changes in time (daylight saving time). A manual compass requires specifications of its position to find another point on the earth. GPS is a way of knowing the position of the instrument at a specific point.

If one knows ones position on the earth it is easy to find out the position of a different point on the earth using GPS. A wristwatch size GPS will be used to show a symbolic representation of Mecca, which lies 21.27 degree north and 39.49 degree east. As a person moves from one position in the world to another the symbol will move. It will point toward west if you are in Japan and east if you are in Egypt, south if you are in Russia and north if you are in Yemen. It will point in the exact direction of Mecca no matter where you are in the world.

Time is a function of latitude and longitude. We know that there are seasonal adjustments for time such as daylight savings time in the U.S.A. We know that every point on the earth at any given movement has a specific time. A table will be inserted with times at various ranges of coordinates in the world, which will be linked to the GPS. The movement of the watch form one coordinate to another will make the time change automatically without adjustments. A calendar specifying the day of the month in which time changes will be programmed in the chip, thereby eliminating the time adjustments for seasonal changes.

Tables are available worldwide for islamic prayer timings based on latitude and longitudes. The chip will carry a table of islamic prayer timings based on latitude and longitude (Algorithms are available). The GPS will be operational all the time and will look up the timings for five islamic prayers. The color of the dial will be made to change as the time for prayer changes (Fajr, Zuhar to Asar, Maghrib to Ishan). Five different bulbs will be used to display the proper islamic prayer that can be offered at a given time or obligatory prayers cannot be offered. The lighting of the bulb will change the color of the dial. The rest of the watch will be based on existing technology, it will be a battery operated digital electronic watch.

### SUMMARY OF INVENTION

The invention aims at automating the time changes which have to be made when going form one time zone to another.

The present invention is also made with a view to avoid carrying a compass or GPS instrument to find the location of Mecca from an unfamiliar position in the world.

Manual adjustments for arbitrary changes in time in U.S.A. will not be required.

Another aim of the invention is to know if a particular islamic prayer can be offered at any given time.

1. A wristwatch, which can show time without adjustments from one time zone to another.

2. A wristwatch, that can give the direction of Mecca from any point in the world.

3. A wristwatch, that can show if a particular islamic prayer can be offered at any specific time of the day.

4. A wristwatch, that can show time without adjustments for daylight savings time in the U.S.A.
